(19) United States
(12) Patent Application Publication
(10) Pub. No.: US 2011/0116921 A1
(43) Pub. Date: May 19, 2011

(54) WATER PUMP PROVIDED WITH A BEARING

(75) Inventors: Seung Yong Lee, Yongin-si (KR); Gyuhwan Kim, Suwon-si (KR); Yun Seok Kim, Yongin-si (KR); Yong Sun Park, Yongin-si (KR); Bong Sang Lee, Suwon-city (KR); Tae-Sung Oh, Ansan-si (KR); Kyung-Hwan Kim, Incheon-si (KR); Jong-Hoon Lee, Incheon-si (KR); Kwang-Ho Lee, Cheonan-si (KR)

(73) Assignees: Hyundai Motor Company, Seoul (KR); Myunghwa Ind. Co., Ltd., Seoul (KR); Amotech Co., Ltd., Incheon-si (KR); Kia Motors Corporation, Seoul (KR)

(21) Appl. No.: 12/875,470

(22) Filed: Sep. 3, 2010

(30) Foreign Application Priority Data
Nov. 19, 2009 (KR) 10-2009-0112243

(51) Int. Cl. F03B 11/00

(52) U.S. Cl. 415/229

(57) ABSTRACT

A water pump that is equipped with a bearing, may include a drive shaft, at least two bearings of an arc type that are mounted around the exterior circumference of the drive shaft and being engaged with each other, a housing that fixes the at least two bearings of the art type therein such that the drive shaft can rotate in the at least two bearings of the arc type.

### CROSS-REFERENCE TO RELATED APPLICATION

The present application claims priority to Korean Patent Application No. 10-2009-0112243 filed on Nov. 19, 2009, the entire contents of which is incorporated herein for all purposes by this reference.

### BACKGROUND OF THE INVENTION

1. Field of the Invention

The present invention relates to a water pump that is provided with a bearing. More particularly, the present invention relates to a water pump that is provided with a bearing and is operated by electricity to circulate a coolant.

2. Description of Related Art

A cooling system of some kind is necessary in any internal combustion engine. If no cooling system is provided, parts would melt from heat of burning fuel and pistons would expand so much they would seize.

The cooling system includes an engine water jacket, a thermostat, a coolant pump, a radiator, a radiator cap, a fan, a fan drive belt, and another necessary belt.

Generally, the coolant pump does not have a self-driving torque. Accordingly, the coolant pump uses kinetic energy transferred from the engine crankshaft.

If the engine is started, the coolant pump is operated regardless of the coolant temperature and the driving condition of the engine in such a manner that the coolant circulates in the water jacket and the radiator of the engine.

Because the coolant is forcibly circulated before the engine is warmed up, the exhaust gas temperature is raised slowly. Meanwhile, the exhaust gas temperature has to be raised to a high temperature, for example 250° C., so as to improve the purification efficiency of the exhaust gas to a normal condition.

Recently, a motor driven coolant pump has been applied to the engine, and the motor driven coolant pump decreases the warm-up time of the engine and improves the fuel efficiency.

However, bearings are mounted on the drive shaft of a motor that rotates the water pump, and the bearing has to have a long lifespan and good water-tightness, and has to be easily assembled on the drive shaft.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY OF THE INVENTION

Various aspects of the present invention are directed to provide a water pump that is provided with a bearing having advantages of being easily assembled, and having a secure structure and good water-tightness.

In an aspect of the present invention, the water pump that is equipped with a bearing, may include a drive shaft, at least two bearings of an arc type that are mounted around the exterior circumference of the drive shaft and being engaged with each other, a housing that fixes the at least two bearings of the art type therein such that the drive shaft can rotate in the at least two bearings of the arc type.

Each circumferential length of the arcs in the at least two bearings may be substantially equal.

A mounting groove may be formed in the circumference direction of the drive shaft on the outer surface of the drive shaft with a predetermined depth, and the interior circumferences of the at least two bearings slidably may contact the exterior circumference of the mounting groove.

A longitudinal length of the at least two bearings may be substantially equal to a longitudinal length of the mounting groove.

The exterior circumferences of the at least two bearings may protrude by a predetermined height from the exterior circumference of the drive shaft.

The housing may contact first lateral side surfaces and the exterior circumferences of the at least two bearings.

The drive shaft may have a pipe structure of which a center shaft portion is hollow.

The interior circumferences of the at least two bearings may contact the exterior circumference of the drive shaft, and ribs may be monolithically formed on the exterior circumference of the drive shaft with a predetermined distance therebetween along a longitudinal direction of the drive shaft and wherein the at least two bearings are mounted between the ribs and supported by the ribs.

The interior circumferences of the at least two bearings may contact the exterior circumference of the drive shaft, and ribs may be mounted on the exterior circumference of the drive shaft with a predetermined distance therebetween along a longitudinal direction of the drive shaft by a fixing member and wherein the at least two bearings are fixed between the ribs and supported by the ribs.

The at least two bearings of the arc type may include a first bearing of a semi-circular type that is mounted on one side of the exterior circumference of the drive shaft, and a second bearing of a semi-circular type that is mounted on the other side of the exterior circumference of the drive shaft and being engaged with the first bearing between the one side and the other side.

As stated above, in a water pump that is provided with a bearing according to the present invention, first and second bearings of a semi-circular type are mounted in the mounting groove of the drive shaft such that the assembly becomes easy, and the assembly structure between the bearings and the drive shaft becomes strong.

Further, the side surface and the interior circumference of the bearing respectively contacts with the inner side surface and the exterior circumference of the mounting groove, and the exterior circumference and the side surface thereof securely contact with the housing such that the water-tightness and durability are improved.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1 is a perspective view of an exemplary water pump according to the present invention.

FIG. 2 is a cross-sectional view of an exemplary water pump according to the present invention.

FIG. 3 is a partial exploded perspective view of an exemplary water pump according to the present invention.

FIG. 4 is a partial exploded side view of an exemplary water pump according to the present invention.

FIG. 5 is a partial exploded sectional view of an exemplary water pump according to the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION OF THE INVENTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

An exemplary embodiment of the present invention will hereinafter be described in detail with reference to the accompanying drawings.

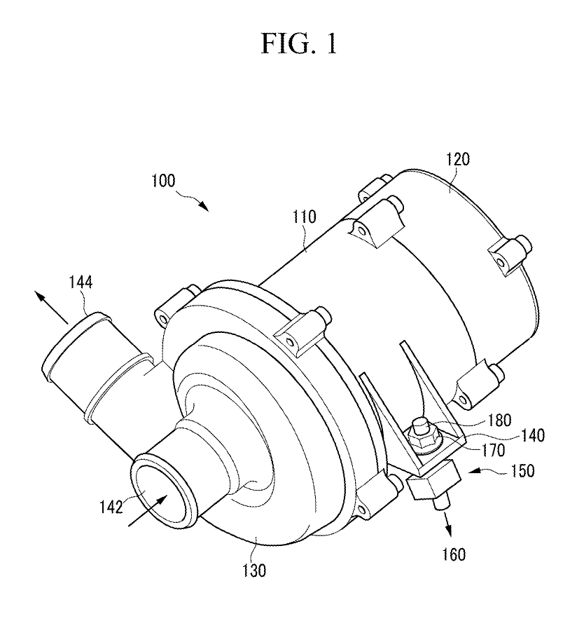

FIG. 1 is a perspective view of a water pump according to an exemplary embodiment of the present invention.

Referring to FIG. 1, the water pump 100 includes a motor housing 110, a driver case 120, an impeller housing 130, and a bracket 140.

A stator, a rotor, and a drive shaft are disposed in the motor housing 110 as constituent elements of an electric motor, and an electricity supply set is disposed in the driver case 120 so as to supply the stator or the rotor with the electricity.

An impeller is disposed in the inner space of the impeller housing 130, and an inlet 142 for drawing in the coolant and an outlet 144 for supplying the coolant are formed in the impeller housing 130.

The bracket 140 is mounted on one side of the exterior circumference of the motor housing 110, and the water pump 100 is fixed on the cylinder block of the engine through the bracket 140.

A bush 150 is interposed between the bracket 140 and the cylinder block, a fastening bolt 180 penetrates the bracket 140, the bush 150, and the cylinder block 160, and a nut 170 is engaged with the bolt 180 in such a manner that the water pump 100 is fixed on the cylinder block 160.

The bush 150 securely fixes the water pump 100 on the cylinder block, and simultaneously absorbs vibration that is generated from the water pump 100 and the cylinder block.

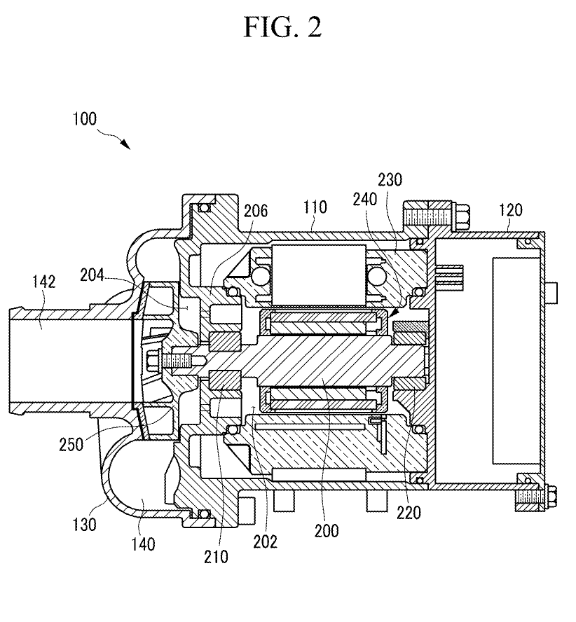

FIG. 2 is a cross-sectional view of a water pump according to an exemplary embodiment of the present invention.

Referring to FIG. 2, a drive shaft 200 is disposed to penetrate a barrier 206 of the motor housing 110 of the water pump 100, and an impeller 250 is mounted on one end portion of the drive shaft 200 that protrudes out of the barrier 206. Here, the impeller 250 is disposed inside the impeller housing 130.

In the inside of the motor housing 110, a rotor unit 240 is disposed on the drive shaft 200 to rotate together with the drive shaft 200, and a stator unit 230 is fixed on the motor housing 110 corresponding to the rotor unit 240.

The stator unit 230 or the rotor unit 240 receives electric power from the power supply portion that is mounted in the drive case 120 to rotate the impeller, such that the impeller draws in the coolant through the inlet 142 and pumps the coolant through the outlet 144.

Referring to FIG. 2, the barrier 206 of the motor housing 110 is disposed between the impeller 250 and the rotor unit 240, the drive shaft 200 penetrates the barrier 206, and a front bearing 210 is interposed between the barrier 206 and the drive shaft 200.

The front bearing 210 seals a pump room 204 of the impeller housing 130 from a rotor chamber 202 in which the rotor unit 240 is disposed, and simultaneously functions as a rotation bearing of the drive shaft 200. Further, a rear bearing 220 is disposed on the rear end portion of the drive shaft 200 corresponding to the front bearing 210.

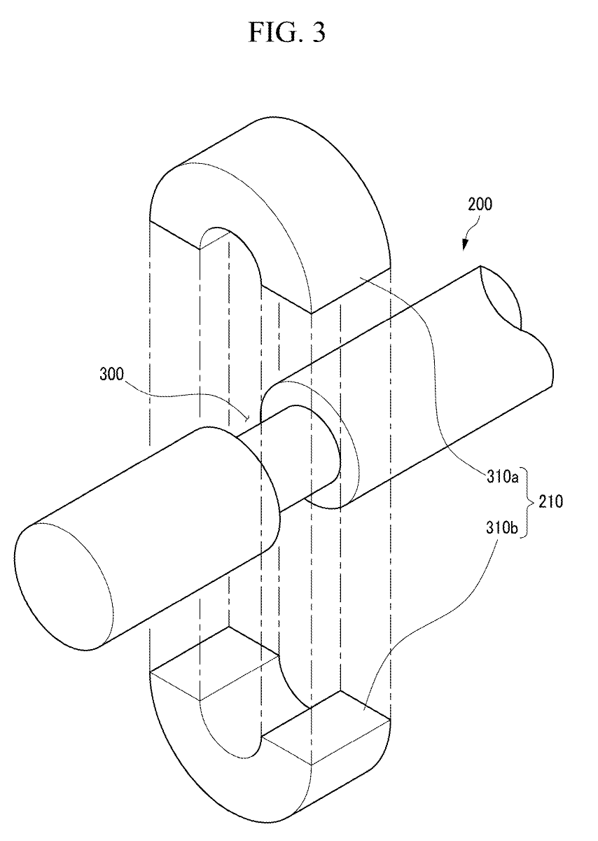

Referring to FIG. 3, the structure of the front bearing 210 and the drive shaft 200 are explained. FIG. 3 is a partial exploded perspective view of a water pump according to an exemplary embodiment of the present invention.

Referring to FIG. 3, a mounting groove 300 is formed on the exterior circumference of the drive shaft 200. Here, the mounting groove 300 is formed along the circumference of the drive shaft 200.

Also, the front bearing 210 and/or the rear bearing 220 (hereinafter, “bearing”) may include at least two bearings of an arc type and in an exemplary embodiment of the present invention may include a first bearing 310a and a second bearing 310b.

The first bearing 310a and the second bearing 310b each have a semi-circular arc shape, and the interior circumference thereof contacts the exterior circumference of the mounting groove 300.

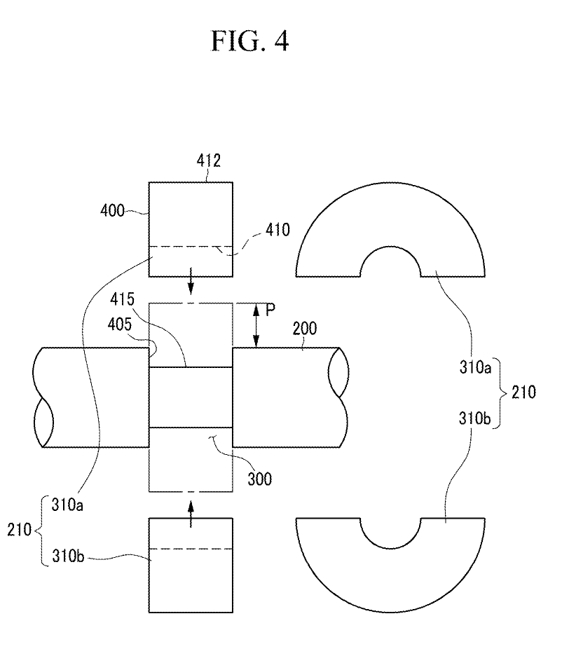

FIG. 4 is a partial exploded side view of a water pump according to an exemplary embodiment of the present invention.

Referring to FIG. 4, a bearing side surface 400 of the first bearing 310a contacts an inner side surface 405 of the mounting groove 300, a bearing interior circumference 410 contacts an groove exterior circumference 415, such that the coolant of the pump room 204 of the impeller housing 130 cannot permeate into the rotor chamber 202 of the motor housing 110.

Further, referring to FIG. 2 and FIG. 4, the barrier 206 of the motor housing 110 that is disposed between the impeller 250 and the rotor unit 240 contacts the bearing side surface 400 of the first bearing 310a and the bearing exterior circumference 412 such that the coolant of the pump room 204 of the impeller housing 130 cannot permeate into the motor housing 110.

Further, the bearing exterior circumference 412 of the first and second bearings 310a and 310b protrudes from the exterior circumference by a predetermined distance (P).

Because of the above structure, the first and second bearings 310a and 310b are divided to be engaged with the mounting groove 300 such that the assembly becomes easy. Also, the first and second bearings 310a and 310b are mounted in the mounting groove 300 such that the drive shaft 200 is securely fixed in a length direction thereof.

Further, the first and second bearings 310a and 310b protrude from the exterior circumference of the drive shaft 200 by a predetermined length P, and the side surface 400 and the exterior circumference 412 thereof are supported by the barrier 206 to be securely fixed.

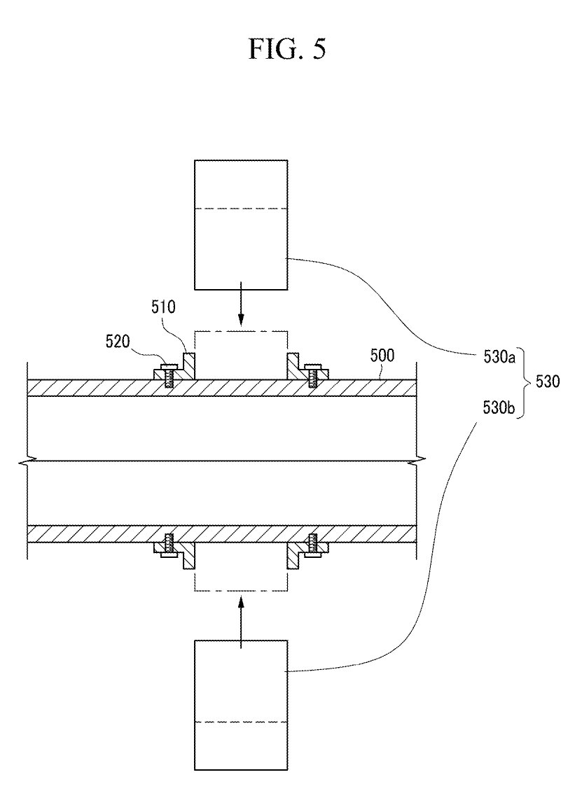

FIG. 5 is a partial exploded sectional view of a water pump according to another exemplary embodiment of the present invention.

Referring to FIG. 5, a drive shaft 500 has a pipe structure in which the center thereof is hollow, a bearing 530 is mounted on the drive shaft 500, the bearing 530 includes a first bearing 530a and a second bearing 530b, and the first bearing 530a and the second bearing 530b are separately mounted on the exterior circumference of the drive shaft 500.

Further, a rib 510 is mounted on the drive shaft 500 so as to prevent the first and second bearings 310a and 310b from moving in a length direction of the drive shaft 500. Here, the rib 510 can be integrally formed with the drive shaft 500, or can be formed by a separate fixing member 520.

For convenience in explanation and accurate definition in the appended claims, the terms “interior” and “exterior” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A water pump that is equipped with a bearing, comprising:
a drive shaft;
at least two bearings of an arc type that are mounted around the exterior circumference of the drive shaft and being engaged with each other;
a housing that fixes the at least two bearings of the art type therein such that the drive shaft can rotate in the at least two bearings of the arc type.

2. The water pump of the claim 1, wherein each circumferential length of the arcs in the at least two bearings is substantially equal.

3. The water pump of claim 1, wherein a mounting groove is formed in the circumference direction of the drive shaft on the outer surface of the drive shaft with a predetermined depth, and the interior circumferences of the at least two bearings slidably contact the exterior circumference of the mounting groove.

4. The water pump of claim 3, wherein a longitudinal length of the at least two bearings is substantially equal to a longitudinal length of the mounting groove.

5. The water pump of claim 3, wherein the exterior circumferences of the at least two bearings protrude by a predetermined height from the exterior circumference of the drive shaft.

6. The water pump of claim 3, wherein the housing contacts first lateral side surfaces and the exterior circumferences of the at least two bearings.

7. The water pump of claim 1, wherein the drive shaft has a pipe structure of which a center shaft portion is hollow.

8. The water pump of claim 7, wherein the interior circumferences of the at least two bearings contact the exterior circumference of the drive shaft, and ribs are monolithically formed on the exterior circumference of the drive shaft with a predetermined distance therebetween along a longitudinal direction of the drive shaft and wherein the at least two bearings are mounted between the ribs and supported by the ribs.

9. The water pump of claim 7, wherein the interior circumferences of the at least two bearings contact the exterior circumference of the drive shaft, and ribs are mounted on the exterior circumference of the drive shaft with a predetermined distance therebetween along a longitudinal direction of the drive shaft by a fixing member and wherein the at least two bearings are fixed between the ribs and supported by the ribs.

10. The water pump of the claim 1, wherein the at least two bearings of the arc type include:
a first bearing of a semi-circular type that is mounted on one side of the exterior circumference of the drive shaft; and
a second bearing of a semi-circular type that is mounted on the other side of the exterior circumference of the drive shaft and being engaged with the first bearing between the one side and the other side.
